(19) United States
(12) Patent Application Publication
(10) Pub. No.: US 2016/0054585 A1
(43) Pub. Date: Feb. 25, 2016

(54) TWIST AND PIVOT EYEGLASSES

(71) Applicant: Gerard Alcini, Algonac, MI (US)

(72) Inventor: Gerard Alcini, Algonac, MI (US)

(21) Appl. No.: 14/835,269

(22) Filed: Aug. 25, 2015

Related U.S. Application Data
(60) Provisional application No. 62/041,336, filed on Aug. 25, 2014.

(51) Int. Cl. G02C 5/20; G02C 5/14

(52) U.S. Cl. CPC G02C 5/20; G02C 5/146; G02C 2200/24

(57) ABSTRACT

A twist and pivot eyeglasses have hinges at the interfaces of a pair of temples and opposed ends of an eyeglass frame. The hinges provide two angularly disposed axes of locations of the temples relative to the eyeglass frame enabling the temples to be twisted from an extended, open position relative to the frame to an inverted position prior to folding relative to the frame in a compact storage position. A detent is form in the eyeglass frame and temple interface to releasably latch the temple in at least one of the open and folded positions.

### CROSS REFERENCE TO CO-PENDING APPLICATION

This application claims priority benefit to the Aug. 25, 2014 filing date of co-pending U.S. provisional patent application Ser. No. 62/041,336 for TWIST AND PIVOT EYEGLASSES filed in the name of Gerard Alcini, the entire contents of which are incorporated herein in its entirety.

### BACKGROUND

The present disclosure relates to eyeglasses and sunglasses.

Eyeglasses, as shown in FIG. 1 and in a portion of FIG. 5, come in many styles and shapes, all of which, however, share common elements. For example, eyeglasses 320 include an eyeglass frame 322 having a frame front portion 324 which holds a pair of lenses 26. A pair of frame ends 330 and 332 is located at the ends of the frame front portion 324. Each frame end 330 and 332 provides a connection point for a hinge which allows a pair of temples 334 and 336 which extend from the frame ends 330 and 332, respectively, and sit on the user's ears to support the eyeglasses 320 on the user, to be pivoted between an extended open-use position, FIG. 1, and a folded over non-use storage position, FIG. 9.

The hinges are connected between the frame ends 30 and 32 and the respective temples 334 and 336 and form vertical pivot axes which allow the temples 34 and 36 to be pivoted from the extended use position shown in FIG. 1 for supporting in the eyeglasses 20 on the user's head to the folded over, storage, non-use position shown in FIG. 7 where the temples 334 and 336 pivot about the respective vertical hinge axis to a folded over position.

Some eyeglasses, such as the eyeglasses 320 shown in FIGS. 1 and 7, have a significant curvature of the temples for styling as well to fit snugly around the generally curved sides of a user's head. When the temples 334 and 336 are folded over to their storage position shown in FIG. 7, a considerable amount of space exists between the frame 324 and the folded over temples 334 and 336.

### SUMMARY

Eyeglasses have an eyeglass frame with opposed frame ends and a pair of temples movably coupled to the frame ends. A hinge is coupled between each frame end and one of the temples, the hinge providing first and second angularly disposed axes of rotation of a temple relative to the frame end. The hinge includes a first pin coupled to one frame end, the first pin defining a first axis of rotation of one temple associated with the one frame end; and a second pin movably coupled to the first pin and carried by the temple, the second pin defining a second axis of rotation of the temple relative to the frame end, the second axis of rotation angularly disposed from the first axis of rotation.

The first and second axes of rotation can be perpendicularly disposed axes of rotation.

The hinge further includes a biasing means exerting a biasing force between the second pin and the temple biasing the temple into engagement with one frame end.

A bore is formed in the second pin. The first pin extends through the bore, with the second pin rotatable about the first pin.

A recess is formed in each temple of the eyeglasses. The second pin is disposed in the recess.

A cover is removably engageable with the recess in the temple to close the recess.

In one aspect, the first pin is fixed to the frame. The first pin can be threaded to internal threads in the frame.

In one aspect, each temple has first and second ends. Each temple having an arcuate shape between the first and second ends and concavely bends between the first and second ends with respect to a center axis through the frame.

In one aspect, a detent and a projection are carried on the each end of the frame and the temples to stabilize the position of each temple in one of an extended open position and in the closed storage position with respect to the frame when the detent is engaged with the detent receiver. The detent and the projection can include a first recess and a first projection disposed in releasable engagement.

In one aspect, a detent and a projection are carried on an engageable end of the frame and a temple. The projection is carried on an end of one of the temple and the frame and engageable with a first cavity of the detent in the other of the temple and the frame to stabilize the temple and the frame in an extended open position.

In another aspect, the detent and projection can include first and second spaced projections carried on the end of one of the temple and the frame and releasably engageable with a first cavity in each of a pair of upper and lower detents in one of the temple and the frame.

A second cavity can also be formed in each detent, spaced from the first cavity. The projection carried on an end of one of the temple and the frame is releasably engageable with the second cavity when the temples are in a folded storage position relative to the frame.

### BRIEF DESCRIPTION OF THE DRAWING

The various features, advantages and other uses of the present twist and pivot eyeglasses will become more apparent by referring to the following description and drawing in which:

FIG. 1 is a plan view of prior art eyeglasses;

FIG. 2 is a plan view of twist and pivot eyeglasses described hereafter;

FIG. 3 is a partial perspective view of the first and second pins of the hinge shown in FIG. 3;

FIG. 4 is an enlarged, exploded, perspective view showing the mounting of the hinge between the eyeglass frame and one temple;

FIG. 5 is a side perspective view showing the twisting movement applied to the temples prior to folding the temples toward the eyeglass frame;

FIG. 6 is a plan view showing the angular disposition of the temples after the folding movement shown in FIG. 5 has been completed;

FIG. 7 is an overlapped plan view showing the present twist and pivot eyeglasses in a folded position and overlaid on the prior art eyeglasses shown in FIG. 1 also depicted in a folded position;

FIG. 8 is an exploded, enlarged perspective view showing another aspect of the twist and pivot eyeglasses;

FIG. 9 is a perspective view showing the eyeglasses depicted in FIG. 8 with the frame and temple in an engaged, open position;

FIG. 10 is a perspective view, similar to FIG. 9, showing additional details of the interaction of the temple and the eyeglass frame;

FIG. 11 is a perspective view similar to FIGS. 9 and 10, but depicting the mounting of the second pin in the temple and the eyeglass frame;

FIG. 12A is an exploded perspective view showing the cover for the recess in the temple;

FIG. 12B is an enlarged perspective view showing the rear surface of temple recess cover shown in FIG. 12A;

FIG. 13 is an enlarged, partial perspective view showing the initial pull back step in the folding of the temples of the eyeglasses shown in FIG. 8;

FIG. 14 is an enlarged, partial perspective view showing the next step in the folding of the temples toward the frame of the eyeglasses shown in FIG. 8;

FIG. 15 is an enlarged, partial perspective view showing the completion of the twisting movement of the temples relative to the eyeglass frame;

FIG. 16 is a plan view of the eyeglasses of FIGS. 8-15 in the twisted, but not yet folded state;

FIG. 17 is an enlarged, partial perspective view showing the engagement of the temple hinge detent projections in the second recess of the detent receiver in the eyeglass frame; and

FIG. 18 is a plan view of the eyeglasses shown in FIGS. 8-17 in a compact folded state.

### DETAILED DESCRIPTION OF THE DRAWING

As shown in FIGS. 2-7, a unique hinge assembly or hinge 60 provides intersecting two axis movement of each temple 34 and 36 relative to respective opposed frame ends 30 and 32 of a frame 22 of the eyeglasses 20 to provide a compact overlapping storage position of the temples 34 and 36.

As shown in FIGS. 2 and 18, the eyeglass frame 22 has, by example, a curved or arcuate shape between the frame ends 30 and 32. This arcuate shape can be a continuous constant radius curve or a compound curve where the frame ends 30 and 32 are formed at a smaller radius than the front portion 24 of the eyeglass frame.

As shown in FIGS. 2 and 18, each temple 34 and 36 has an arcuate shape, which may be a smoothly curved shape or an arcuate shape which extends along a portion of perpendicular center axis through the nose piece 28 extending in between the temples 34 and 36. The length of each temple 34 and 36 to the linear ear end portion 345. This concave shape, relative to an interior side of the eyeglass frame 22, which, by example, in FIG. 18, is depicted as having a similar concave or arcuate shape, allows both temples 34 and 36 to be disposed side by side in a closely spaced position inside a plane extending between the end surfaces 420 of each end 30 and 32 of the frame 22 to form a compact storage position of the eyeglasses 20.

A nose or bridge section 28 is part of the eyeglass frame 22 and spans the front portion 24 of the eyeglass frame 22 to seat the eyeglasses 20 on the bridge of a user's nose. The hinge 60 includes a first pin 62 which defines a first axis of rotation 64 in a bore 65 in the frame 22, also hereafter referred to as the vertical axis due to the mounting orientation of the first pin 62 in the frame ends 30 and 32 of the eyeglass frame 22.

The first pin 62 includes a generally cylindrical shaft 63 which may be smooth along an intermediate portion between first and second ends 66 and 68, or threaded along all or a portion of its entire length. At least the first end 66 of the first pin 62 is threaded to securely and yet removably attach the first pin 62 to one of the frame ends 30 and 32 of the eyeglass frame 22.

The opposite second end 68 of the first pin 62 may have an enlarged head. Regardless of whether or not the second end 68 is enlarged, a screwdriver receiving recess 69 for flathead screwdriver or a Phillips head screwdriver, can be provided in the end exterior portion of the second end 68 of the first pin 62 for threading and unthreading of the first pin 62 with respect to the frame ends 30 and 32.

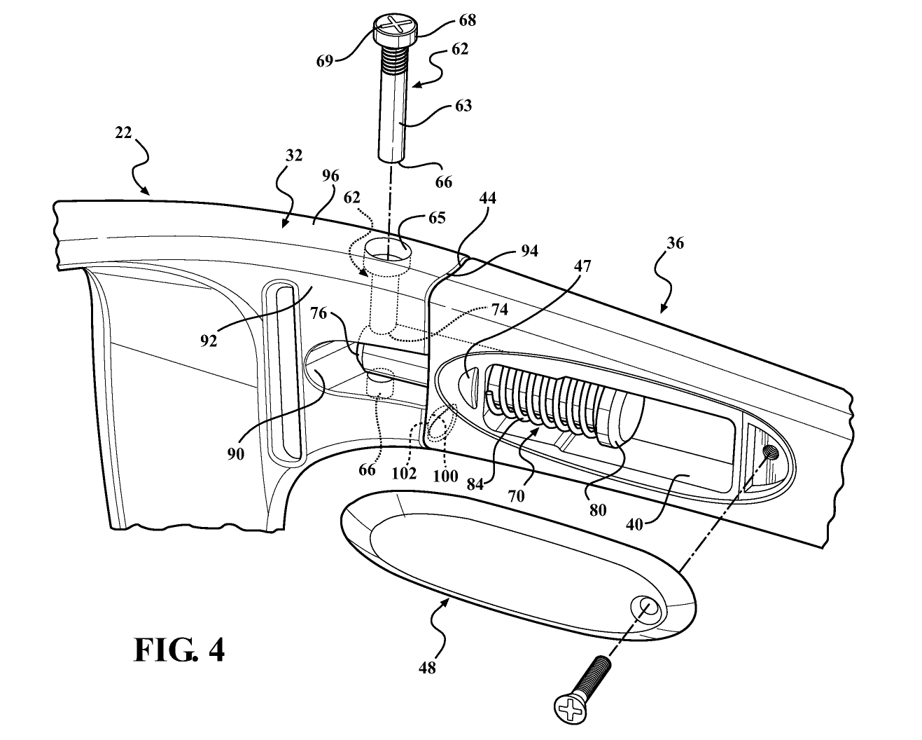

An open ended recess 40 is formed in the end of each temple 34 and 36. The recess 40 opens from an inside surface of each temple 34 and 36. One end 42 of the recess 40 is spaced from an end surface 44 of each temple, such as temple 36. A bore 50 extends through a solid end portion of each temple, such as temple 36. A cover 48, shown in FIG. 4, is removably attached to the temple 36 removably covering the open end of the recess 40. The cover 48 may be releasably attached to the temple 36 via a snap end, screw end or similar connections.

For example, the cover 48 may have a recess at one end configured to receive a projection 47 formed on the temple 36 as shown in FIG. 4. This positions one end of the cover 48 with respect to the temple 36 and allows an opposed end of the cover 48 having a configuration to slip into and cover an opening in the temple 36, also shown in FIG. 4, and to receive a screw to removably attach the opposed end of the cover 48 to the temple 36.

The hinge 60 includes a second pin 70 which defines a second axis 72 of rotation of the temples 34 and 36. The second axis 72 of rotation is angularly disposed from the first axis 64. The first and second axes 64 and 70 intersect and are angularly disposed, such as perpendicular angle with respect to each other. A through bore 74 is formed in the second pin 70 adjacent a first end 76 of the second pin 70, to accommodate the shaft 63 of the first pin 62 and to allow the second pin 70 to pivot or rotate about the second axis 72 relative to the first axis 64 defined by the first pin 62. The bore 74 may be smooth or threaded to allow the pivotal movement of the second pin 70 relative to the first pin 62.

The second pin 70 includes an elongated, generally cylindrical shaft 78 which may have a smooth outer surface. The outer diameter of the shaft 78 is sized to slidably fit through a bore 50 in the end of a temple piece, such as temple 36.

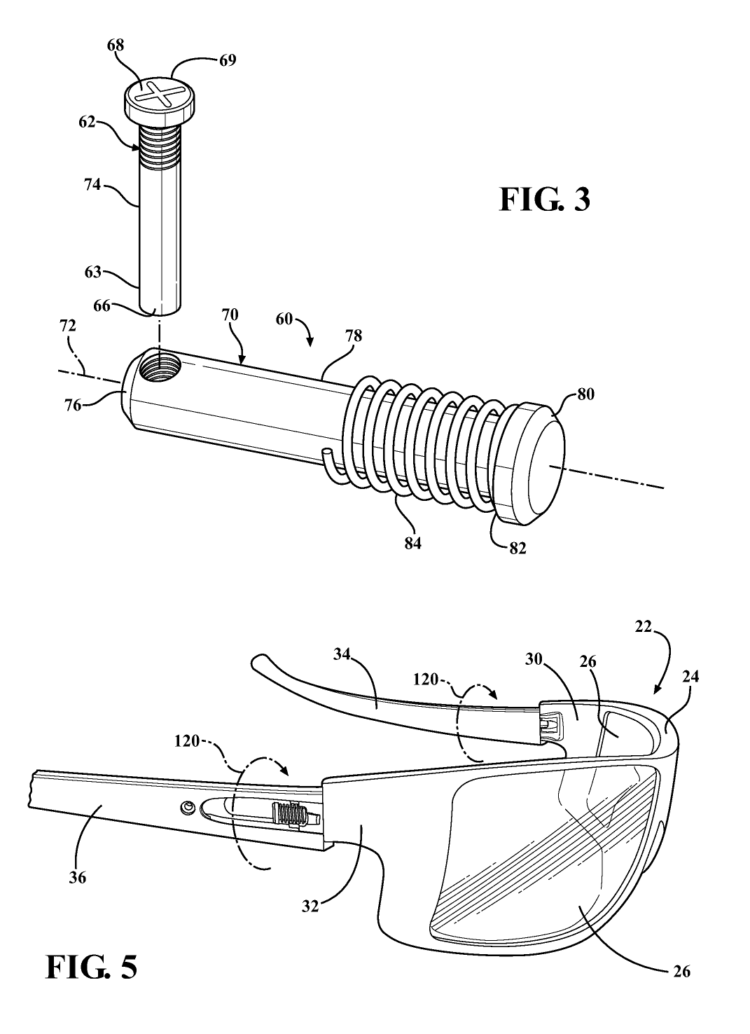

The shaft 78 includes an enlarged head-shaped second end 80 opposite from the first end 76. The enlarged head 80 defines a seat 82 for a biasing means, such as a coil spring 84, which seats at one end on a seat 82 and at an opposite end on the end 42 of the recess 40 surrounding the bore 50 in the temple 36 as shown in FIG. 3.

The second pin 70, carrying the biasing means or spring 84, is inserted into the recess 40 in the temple 36. The first end 76 of the second pin 70 is slid through the bore 50 in the end of the temple 36.

As shown in FIG. 3, a recess 90 is formed in each frame end 30, 32 and may open to an inside surface 92 of the frame end 32, as well as to an end surface 94 on the frame end 32. The first end 66 of the first pin 62 is threaded from a top surface 96 of the frame end 32, as shown in FIG. 4, through the internal threaded bore 63 at the frame end 32 spanning the recess 90. The bore 63 for the first pin 62 could alternately extend inward from a bottom surface of each frame end 30, 32.

A detent 100, which may be in the form of a depression, is formed in the end surface 94 of the frame end 32 for releasable mating engagement with a complimentarily shaped projection 102 formed in the end surface 44 of the temple 36. The surfaces 94 and 44 may be complimentarily shaped, such as both surfaces 44 and 94 being flat, or one of the surfaces 44 and 94 can be concave and the other surface 44 and 94 can have a complimentarily shaped convex shape to position the temples 34 and 36 in the open position for mounting the eyeglasses 20 on the user's head.

To assemble the eyeglasses 20 with the two rotation axis hinge 60, the second pin 70 is initially installed in the recess 40 as shown in FIG. 4. Pressure can be applied to the second end 80 of the second pin 70, after the second pin 70 is mounted in the recess 40 in the temple 36 to compress the biasing means or spring 84 to extend the first end 76 of the second pin 70 outward from the end surface 44 of the temple 36 and into the recess 90 in the frame end 32, to a position to allow the first pin 62 to be inserted through the frame end 32 and through the bore 74 in the end of the second pin 70 so that the first end 66 of the first pin 62 securely engages the solid portion of the frame end 32. In this position, defined as the normal use position of the eyeglasses 20, the temple 36 projects or extends away from the end 32 of the eyeglass frame 22 and the surfaces 44 and 94 are disposed in substantial engagement.

In this, use position, the temples 34 and 36 assume the open position shown in FIG. 2.

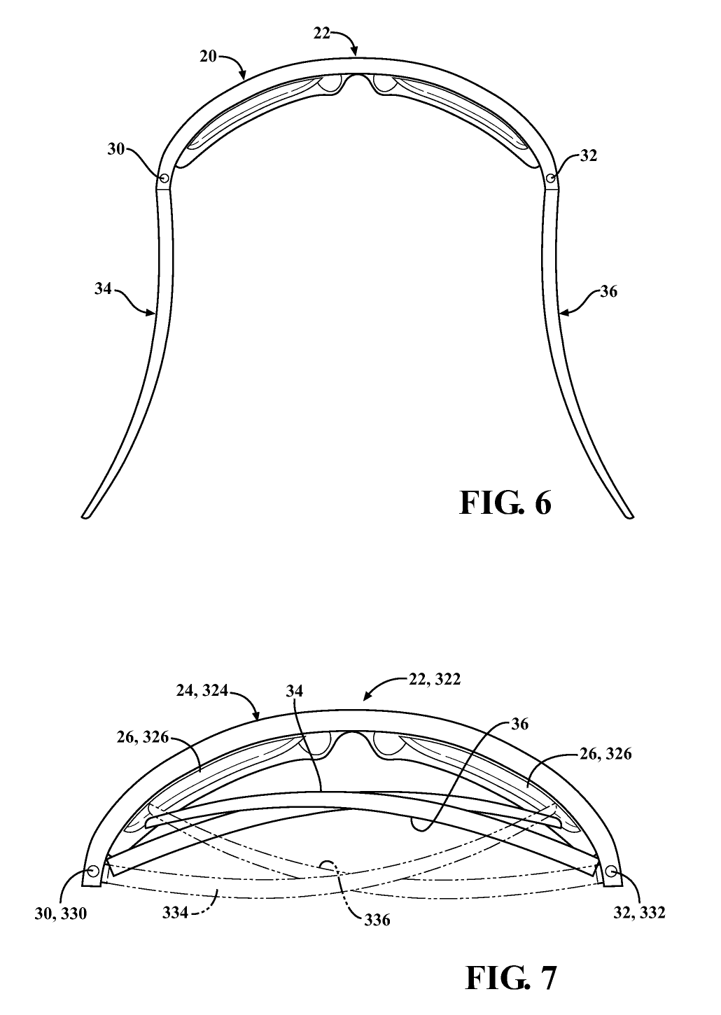

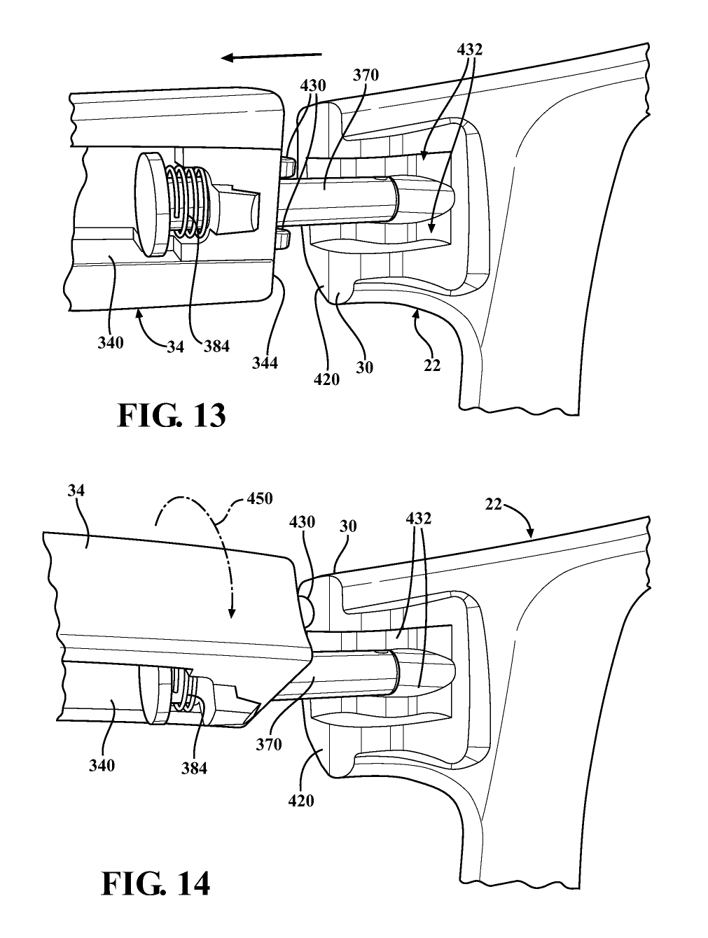

When the user desires to remove the eyeglasses 20 from his or her face and compactly store the eyeglasses 20, the user can exert a longitudinal pulling force on each temple 34 and 36 in a direction outward from the eyeglass frame 22, as described and shown hereafter in detail with respect to FIGS. 13-15. This allows each temple, such as temple 36, to be pivoted in a direction shown by the arrow 120 in FIG. 5 so that previous inner surface of each temple, such as temple 36, faces outward in a direction shown in FIGS. 5 and 6. Temples 34 and 36 are then in a position shown in FIG. 6. Each temple 34 and 36 may then be pivoted about the respective first pin 62 to an inward position facing the eyeglass frame 22 as shown in FIG. 7. Due to the curvature of the temples 34 and 36, the temples 34 and 36, as shown in FIG. 7 pivot into an overlapped position relative to each other in closer proximity to the eyeglass frame 22 and then the prior art temples 34′ and 36′ would do the same, as shown in FIG. 7. FIG. 7 clearly illustrates the more compact storage position of the eyeglasses 20 using the unique two axis hinge assembly 60 described above.

When the user desires to use the glasses, the user simply pivots each temple 34 and 36 about the respective first pin 62 until the temples 34 and 36 are again deployed in the extended outward use position shown in FIG. 6. The user then grasps each temple 34 and 36, separates each temple 34 and 36 from the frame ends 30 and 32, respectively, pivots each temple 34 and 36 about the respective second pin 70, and then releases the pulling force on each temple 34 and 36 so that the projection 102 on each temple, such as temple 36, engages the recess 100 in the frame end 32 as shown in FIG. 7. The mating engagement of the projection 102 in recess 100 provides a secure deployed position of each temple 34 and 36 relative to the eyeglass frame 22.

It will be further understood that the use of the projection 102 and recess 100 may be reversed so that the projection 102 is formed on the end surface 94 of the frame end 32 and the recess 100 formed in the first end 44 of the temple 36 or 34.

Further, the use of the projection 102 and the recess 100 are optional as described above. The end surfaces 94 and 44 may be provided with complimentary curvatures or shapes to provide a secure engagement between the surfaces 44 and 94 when the temple 36 reaches its fully deployed use position.

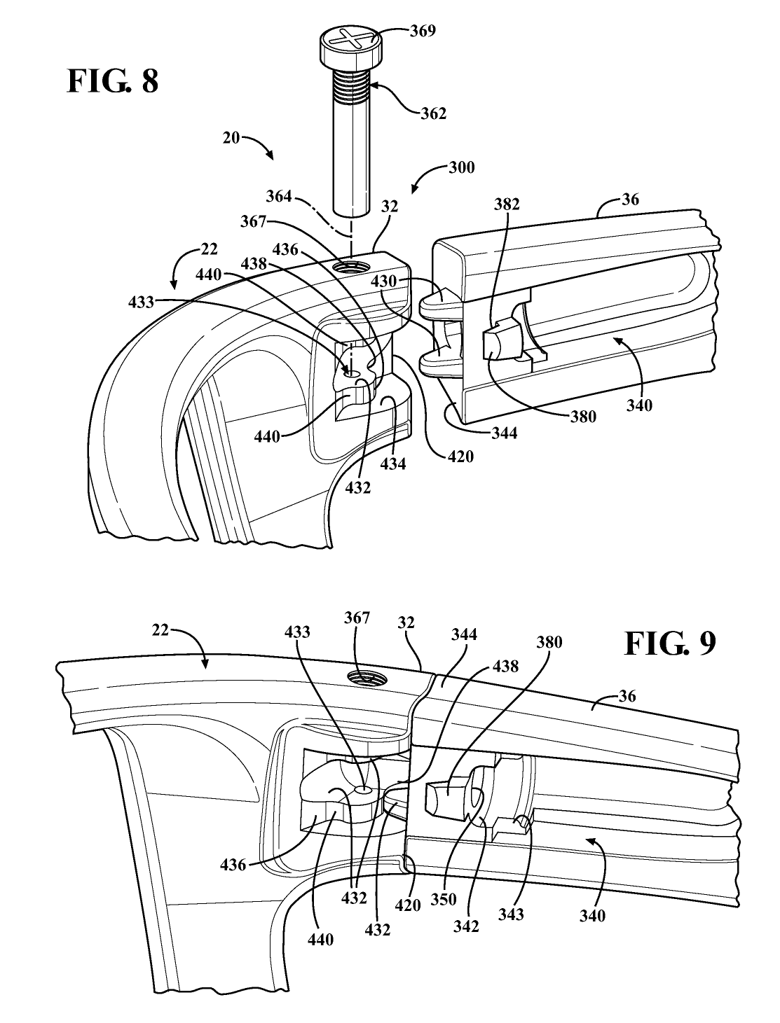

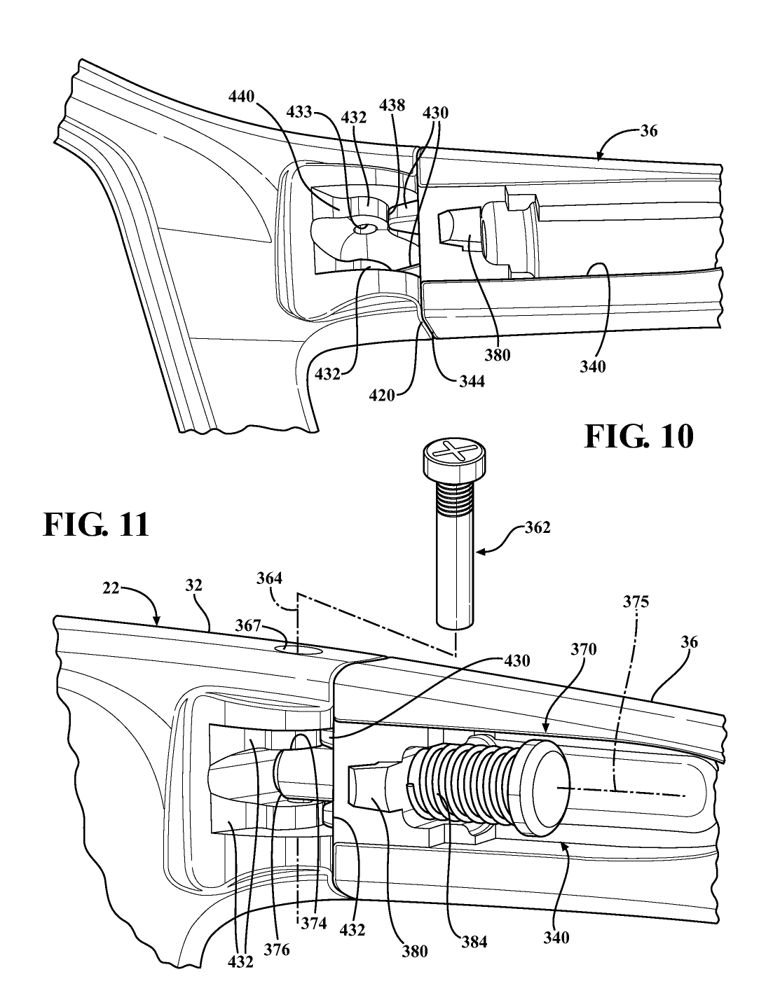

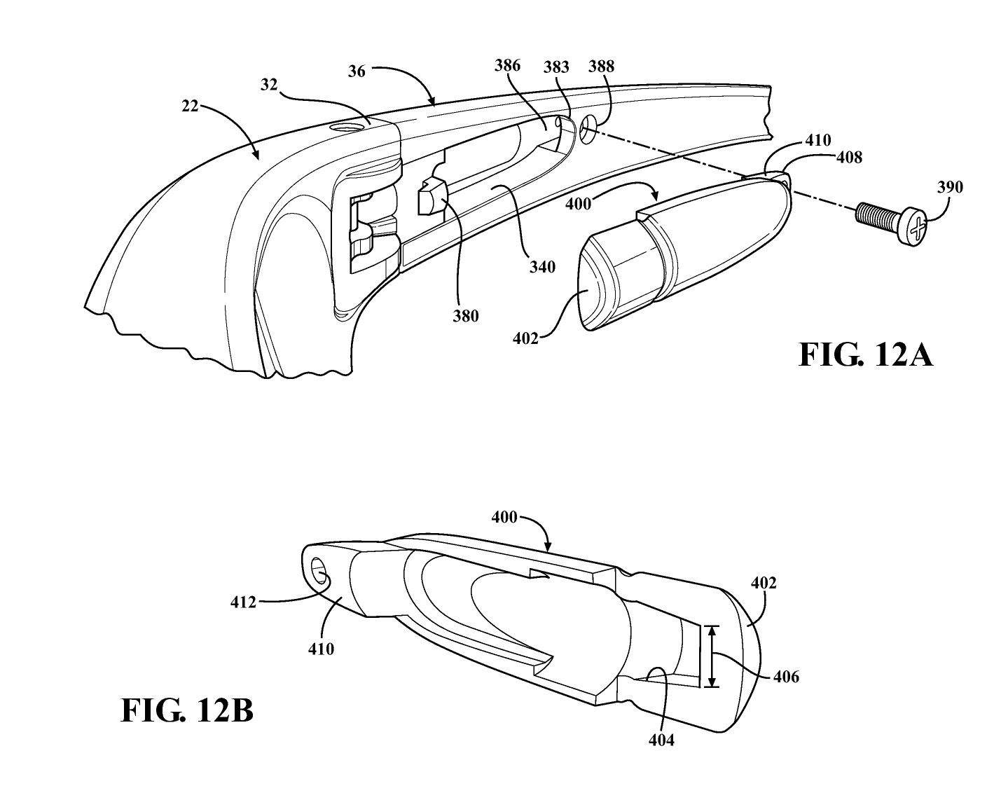

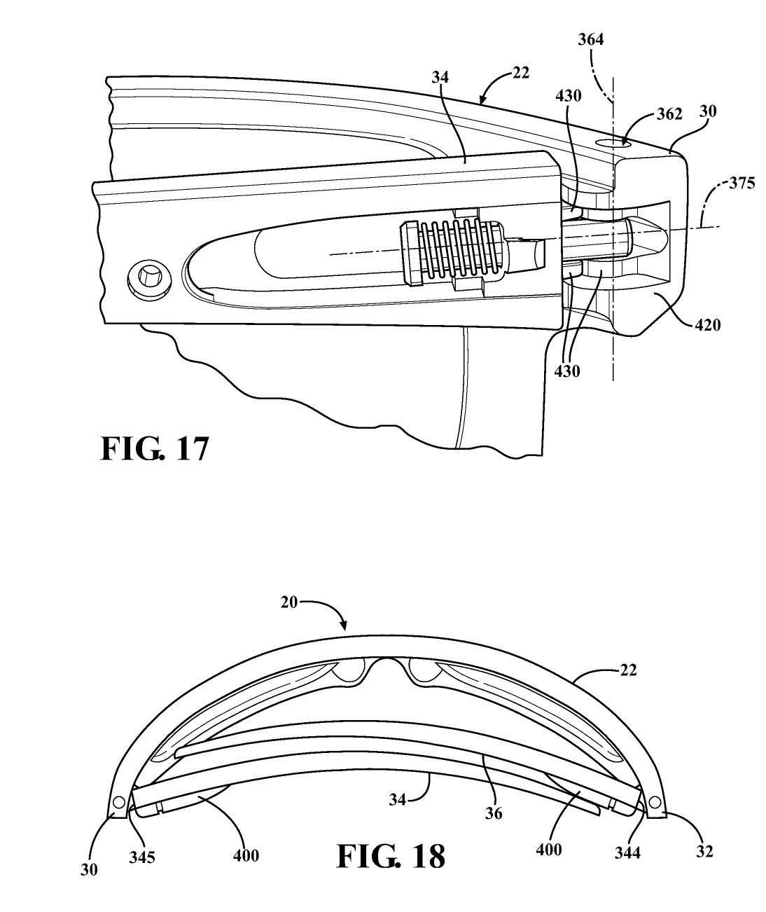

Another aspect of a twist and pivot eyeglasses is shown in FIG. 8-18. In this aspect, the eyeglasses 20 have the same eyeglass frame 22 with the opposed ends 30 and 32, a pair of lenses 26 and nose piece 28. Hinge assemblies 300 pivotally and twistingly connecting each temple 34 and 36 to the ends 30 and 32 of the frame 22 for pivotal movement about two angularly axes.

The hinge assembly 300 includes a first pin 362 which defines a first axis 364 of rotation of each temple, such as temple 36, about the opposed end 32 of the eyeglass frame 22. The first axis 364 of rotation also referred to as a vertical axis due to the mounting orientation of the first pin 362 in the frame ends 30 and 32 of the eyeglass frame 22.

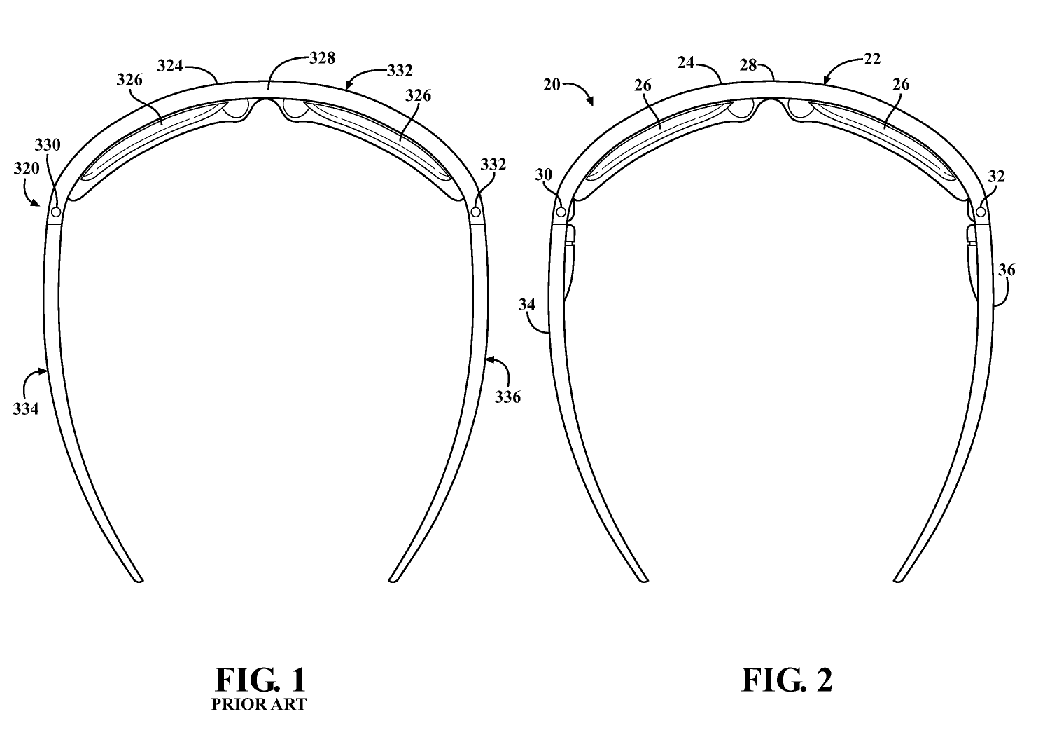

The first 362 is constructed similarly to the first pin 62 described above and shown in FIGS. 1-7 such that further details can be had by referring to the description and attachment of the first pin 62.

Each hinge assembly 300 also includes a second pin 370 which is similarly constructed as the second pin 70 described above and shown in FIGS. 1-7. Further details concerning the construction, use and mounting of the second pin 370 in each temple, such as temple 36 and its movable coupling to the first pin 362 can be had with reference to the description of the first pin 62 above.

An open sided recess 340 is formed in the interior or inside surface of each temple, such as temple 36. The recess 340 has a first inner shoulder 342 and a spaced larger diameter second shoulder 343. The first shoulder 342 annularly surrounds a through bore 350 extending to a solid end of each temple, such as temple 36. The bore 350 extends to an end surface or face 344 on a first end of each temple, such as temple 36, which defines a portion of the interface between each temple, such as temple 36 and the complimentary end, such as end 32 of the frame 22.

The second pin 370 is disposed in the recess 340 in the temple 36 such that first end 376 of the second pin 370 extends through the bore 350 into an intersecting arrangement with the first axis 362 defined by the first pin 362. The second pin 370, when disposed in the recess 340 in the temple 36, defines a second axis 375 angularly disposed from the first axis 364.

A through bore 374 is formed in the second pin 370 spaced from the first end 376 to receive the shaft of first pin 362 thereby coupling the second pin 370 to the first pin 362 for pivotal movement about the first axis 364 as well as allowing axial movement of the temple 36 relative to the end 32 of the frame 22 for twisting or pivotal movement of the temple 36 about a second axis 375, as described in greater detail hereafter, also referred to as a horizontal axis in the orientation of the connection of the temple 36 to the eyeglass frame 22.

As shown in FIGS. 6-14B, a tab 380 having an L-shape disposed on the inner surface of each temple, such as temple 36, with an open end flange 382 spaced from the interior surface of the temple 36 facing the end surface 344 of the temple 36. Similarly, the recess 340 includes a rear wall 383 spaced from the tab 380. An interior cavity 386 extends from the rear wall 383 and into the interior of the temple 36 and intersects a laterally extending cross bore 388. An attachment screw 390 can be threaded through internal threads in the bore 388 into engagement with one end of a cover 400 for the recess 340. As shown in FIGS. 6. 8 and 10, the cover 400 has a shape slightly larger but complimentary to the peripheral shape of the recess 340. One interior end 402 of the cover 400 has an internal cavity 404 with an end lip 406 shaped to snuggly engage the tab 380 with the end lip 406 disposed underneath the end flange 382 on the tab 380.

An opposite end 408 of the cover 400 has an offset flange 410 with a through bore 412. The offset flange 410 is shaped to fit within the recess 340 with the flange 410 extending into the cavity 386 to align the bore 412 in the cover 400 with the lateral bore 388 in the temple 36. The mounting screw 390 can then be threaded through the bore 388 in the temple 36 into engagement within an interior portion of the bore 412 and the cover 400 to removably latch the cover 400 to an interior surface of the temple 36 closing the open side ends of the recess 340.

Since the axial position of the second pin 370 remains fixed in place; each temple, such as temple 34, can be axially and pivotally moved relative to the second pin 370 and the end 32 of the frame 22 along the second axis 375. The biasing means or spring 384 captured between the enlarged head of the second pin 370 and an inner shoulder around bore 350 in the temple 36, exerts the biasing force to securely, yet releasably engage the first end 344 of the temple 36 with a complimentary shaped surface 420 at the end 32 of the frame 22 which completes the interface between the temple 36 and the end 32 of the frame 22. In this position, the temples 34 and 36 are fully extended from the eyeglass frames 22 to the open position allowing the eyeglasses to be placed on or removed from the user's head.

As shown in FIGS. 9-14A, 15, 16, and 18, a detent and a projection or prong are formed on the end surfaces 344 and 420 of each temple, such as temple 36 and each end, such as end 32 of the frame 22 for stabilized engagement between the temple 36 and the frame 22 in both the open extended position of the temple 36 relative to the frame 22 as well as the compact folded or storage position of the temple 36 relative to the frame 22, as described hereafter.

In one aspect, the projection can be a single projection 430 extending from the first end surface 344 of the temple 36. A similar detent and projection 430 are formed between the opposed temple 34 and the opposed end 32 of the frame 22.

A detent 432 is disposed in an open recess 434 in the end 32 of the frame 22. The detent 432 can be in the form of a cavity 438 formed in an undulating, arcuate shaped profile 436. The cavity 438 is complimentary in shape to the projection 430.

When the temple 36 is in the extended position relative to the frame 22 with the first end surface 344 of the temple 36 disposed in engagement with the end surface 420 at the end 32 of the frame 22, at least the tip end portion of the projection 430 seats within the cavity 438 in the detent 432. This aligns the temple 36 with the end 32 of the frame 22 and stabilizes the retention of the temple 36 in the extended open position.

In another aspect, the projection 430 and the detent 432 may be formed as a pair of upper first and a second lower detent projections or prongs 430, and first and second or upper and lower detents 432. The operation of the first upper projection 430 and the first upper mating detent 432 are identical to that described above for first projection 430 and the detent 432.

The profile(s) 436 in the single one or the pair of detents 432 may also have a second cavity 440, spaced from the first cavity 438, the purpose of which will be described hereafter.

Referring now to FIGS. 13-18, the operation of the eyeglasses 20 for pivotal extension and retraction of the temples 34 and 36 relative to the frame 22 will be described. With the temples 34 and 36 in their normal extended position allowing the eyeglasses 20 to be placed on or removed from the user's head, when the user desires to fold the temples 34 and 36 toward the frame 22 for storage, the user first separate the temples, such as temple 34 from the end 30 of the eyeglass frame 22 in an axial direction along the second axis 375 as shown in FIG. 13. This axial movement compresses the biasing means 384 and separates the first end 344 of the temple 34 from the mating end surface 420 at the end 30 of the frame 22, and separates the projection(s) 430 from the detent cavity(s) 438.

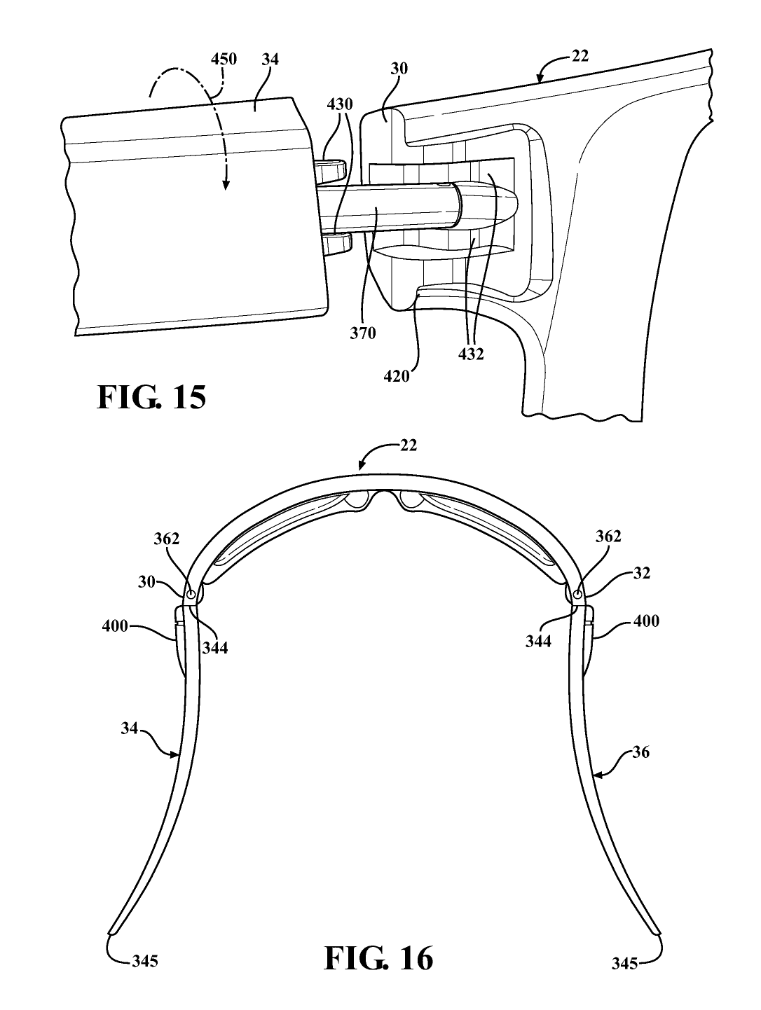

Next, as shown in FIG. 14, the user twists or pivots the temple 34 in the direction of arrow 450 about the second axis 375 defined by the second pin 370, thereby rotating the temple 36 about the second axis 375 approximately 180° until, as shown in FIG. 15, the temple 34 reaches a position in which an exterior surface of the temple 34, when the temple 34 is in the open use position relative to the frame 22 is now disposed inward toward the opposed temple 36. At this time, the user can pivot first one temple 36 and the other temple 34 inward relative to the frame 22 about the first axes 364 formed by the first pins 362 of each hinge 300 until the temples 34 and 36 reach the closed, compact storage position shown in FIG. 18.

In this position, the projections 430 on the temples 34 and 36 of each hinge 300 seat within and engage the second cavity 440 in each profile 436 of each detent 432 in a frame 22 to stabilize the retention of the temples 34 and 36 in the closed storage position.

Releasing the pulling force exerted on the temple 34 allowing the biasing spring 384 to expand and pull the temple 34 back into engagement with the end surface 420 of the frame 22. This brings the projections 430 into engagement with the second cavities 440 in the detents 432 to securely retain the temple 34 in the folded position.

What is claimed is:

1. Eyeglasses including an eyeglass frame having opposed frame ends and a pair of temples movably coupled to the frame ends comprising:
a hinge coupled between a frame end and one of the temples, the hinge providing first and second angularly disposed axes of rotation of a temple relative to the frame end.

2. The eyeglasses of claim 1 wherein:
each temple has first and second ends;
each temple having a arcuate shape between the first and second ends; and
each temple concaving bending between the first and second ends with respect to an interior surface of the eyeglass frame.

3. The eyeglasses of claim 1 wherein the hinge further comprises:
a first pin removably coupled to one frame end, the first pin defining a first axis of rotation of one temple associated with the one frame end; and
a second pin movably coupled to the first pin and carried by the temple, the second pin defining a second axis of rotation of the temple relative to the frame end, the second axis of rotation angularly disposed from the first axis of rotation.

4. The eyeglasses of claim 3 wherein the hinge further comprises:
a biasing means exerting a biasing force between the second pin and the temple biasing the temple into engagement with one frame end.

5. The eyeglasses of claim 3 wherein the hinge further comprises:
the second pin pivotally coupled to the first pin and defining first and second axes of rotation as perpendicularly disposed axes of rotation.

6. The eyeglasses of claim 5 further comprising:
a bore in the second pin;
the first pin extending through the bore; and
the second pin rotatable with respect to the first pin.

7. The eyeglasses of claim 3 further comprising:
a recess in each temple, the second pin disposed in the recess.

8. The eyeglasses of claim 7 further comprising:
a cover removably engageable with the recess on the temple to close the recess.

9. The eyeglasses of claim 3 wherein:
the first pin is fixed to the eyeglass frame.

10. The eyeglasses of claim 9 wherein:
the first pin is threaded to internal threads in the eyeglass frame.

11. The eyeglasses of claim 1 further comprising:
a detent and a projection carried on the ends of the frame and each temple to stabilize each temple in one of an extended open position and a closed storage position with respect to the frame when the projection engages with the detent.

12. The eyeglasses of claim 11 wherein:
the detent and the projection include a first cavity and a first projection disposed in releasable engagement.

13. The eyeglasses of claim 12 wherein:
the detent and the projection include a second cavity and a second projection spaced from the first cavity and the first projection and configured for releasable engagement.

14. The eyeglasses of claim 12 further comprising:
a second cavity spaced from the first cavity; and
the first projection disposed in releasable engagement with the second cavity when the temple is pivoted to a folded position with respect to the eyeglass frame.

15. The eyeglasses of claim 1 further comprising:
a detent in the form of a cavity and a projection carried on engageable ends of the eyeglass frame and the temple; and
the first projection and engageable with a first cavity in the detent in the other of the temple and the frame to stabilize the engagement of the ends of the temple and the frame in an extended open position.

16. The eyeglasses of claim 15 wherein the detent and projection further comprise:
another first projection carried on the end of one of the temple and the frame spaced from the first projection releasably engageable with another first cavity in one of the a pair of detents in one of the temple and the frame, the another first cavity spaced from the first cavity.

17. The eyeglasses of claim 16 further comprising:
a second cavity formed in each of the pair of detents; and
the first projection and the another first projection carried on an end of one of the temple and the frame releasably engageable with the second cavity when the temple is in a folded position relative to the frame.

18. The eyeglasses of claim 1 wherein the hinge further comprises:
a first pin fixed in one frame end and defining a first axis of rotation of one temple relative to the one frame end;
a second pin carried by a temple, the second pin having an end rotatably coupled to the first pin for rotation of the second pin and the temple about the first axis of rotation; and
a spring carried in the temple and acting on the second pin to bias the temple forward to engage an end of the temple with an end of the frame, and allowing the end of the temple to be separated from the end of the frame and the temple rotated about a second axis of rotation formed by the second pin.
